(19) United States
(12) Patent Application Publication
(10) Pub. No.: US 2026/0048801 A1
(43) Pub. Date: Feb. 19, 2026

(54) SADDLE BAG SUPPORT ASSEMBLY FOR A VEHICLE AND VEHICLE HAVING THE SAME

(71) Applicant: BOMBARDIER RECREATIONAL PRODUCTS INC., Valcourt (CA)

(72) Inventors: Simon BLANCHETTE, Sherbrooke (CA); David NEVEU, Sherbrooke (CA); Yoann ROBIN, Valcourt (CA)

(21) Appl. No.: 19/296,308

(22) Filed: Aug. 11, 2025

Related U.S. Application Data
(60) Provisional application No. 63/683,988, filed on Aug. 16, 2024.

(51) Int. Cl. B62J 9/14; B62J 1/08; B62J 1/14; B62K 11/04

(52) U.S. Cl. CPC B62J 9/14; B62J 1/08; B62J 1/14; B62K 11/04

(57) ABSTRACT

A vehicle, a saddle bag support assembly for the vehicle, and a method of deploying said saddle bag support assembly. The vehicle having a frame defining an interior volume, with at least two wheels attached to the frame. A driver straddle seat is supported by the frame and positioned at least partially forward of the interior volume. The vehicle further includes a saddle bag support assembly connected to the frame and moveable between a stowed position, in which at least a portion of the saddle bag support assembly is stowed within the interior volume, and a deployed position, in which at least a majority of the saddle bag support assembly is deployed outside the interior volume. The saddle bag support assembly being configured and arranged to selectively receive a saddle bag when in the deployed position.

### CROSS-REFERENCE

The present application claims priority to the U.S. Provisional Patent Application No. 63/683,988, filed on Aug. 16, 2024, entitled “SADDLE BAG SUPPORT ASSEMBLY FOR A VEHICLE AND VEHICLE HAVING THE SAME”, incorporated by reference herein in its entirety.

### FIELD OF TECHNOLOGY

The present technology relates to vehicle having a saddle bag support assembly.

### BACKGROUND

Vehicles with straddle seats are highly valued for their compact sizes, making them easy to maneuver in limited spaces. This includes, for example, in urban settings where parking space is limited, as well as in off-road environments, such as forests. These types of vehicles include, but are not limited to, two-wheel motorcycles, three-wheel on-road vehicles, and four-wheel all-terrain vehicles (ATVs).

Due to their small size, these vehicles inherently offer limited storage capacity. To address this limitation, drivers mount additional storage accessories, such as saddle bags, to mounting brackets fixed to the vehicle. The mounting brackets provide a secure attachment point for the saddle bags. However, when the saddle bags are not in use, the mounting brackets are exposed which not only detracts from the vehicle's aesthetic appeal but can also lead to an increased risk of damage to the mounting brackets and/or the vehicle.

In view of the foregoing, there is a need for a saddle bag support assembly for a vehicle that addresses at least some of these drawbacks.

### SUMMARY

It is an object of the present technology to ameliorate at least some of the inconveniences present in the prior art.

According to an aspect of the present technology, there is provided a vehicle. The vehicle includes a frame defining an interior volume; at least two wheels attached to the frame; a driver straddle seat supported by the frame and positioned at least partially forward of the interior volume; and a saddle bag support assembly connected to the frame, the saddle bag support assembly being moveable between: a stowed position, in which at least a portion of the saddle bag support assembly is stowed within the interior volume; and a deployed position, in which at least a majority of the saddle bag support assembly is deployed outside the interior volume, the saddle bag support assembly being configured and arranged to selectively receive a saddle bag when in the deployed position.

In some embodiments, the frame defines a first seat rail; and a second seat rail spaced apart from the first seat rail; and the interior volume is defined between the first and second seat rails.

In some embodiments, the frame includes a first side panel, where a portion of an upper edge of the first side panel defines the first seat rail; and a second side panel, where a portion of an upper edge of the second side panel defines the second seat rail.

In some embodiments, one of the at least two wheels is a rear wheel disposed under the interior volume.

In some embodiments, the vehicle further includes a passenger straddle seat removably connected to the frame above the interior volume.

In some embodiments, the vehicle further includes a cover configured to selectively cover the interior volume.

In some embodiments, the saddle bag support assembly is pivotably connected to the frame.

In some embodiments, the saddle bag support assembly is configured to pivot about a pivot axis extending substantially longitudinal to the frame.

In some embodiments, the saddle bag support assembly includes a first arm extending along a side of the frame, the first arm defining the pivot axis; a second arm extending parallel to the first arm, the second arm having a connecting portion configured to connect with the saddle bag; and a link extending between the first and second arms.

In some embodiments, when in the saddle bag support assembly is in the deployed position, the second arm and at least a portion of the link is deployed outside of the interior volume.

In some embodiments, the link is a first link; and the saddle bag support assembly includes a second link extending between the first and second arms, the second link being spaced apart from the first link.

In some embodiments, the connecting portion is a first connecting portion having a first aperture defined in the second arm; and the second arm has a second connecting portion spaced apart from the first connecting portion, the second connecting portion having a second aperture defined in the second arm.

In some embodiments, the frame includes a first side; and a second side, the second side being opposite the first side; the saddle bag support assembly is a first saddle bag support assembly connected to the first side of the frame; and the vehicle further includes a second saddle bag support assembly connected to the second side of the frame.

In some embodiments, the first side is a right side of the frame; and the second side is a left side of the frame.

In some embodiments, the vehicle further includes the saddle bag selectively connected to. the saddle bag support assembly in the deployed position.

In some embodiments, the saddle bag support assembly is connected to the frame within the interior volume.

According to another aspect of the present technology, there is provided a saddle bag assembly for a vehicle. The saddle bag support assembly includes a first arm configured to connect to a frame of the vehicle and extend along a side of the frame, the first arm defining a pivot axis; a second arm extending parallel to the first arm, the second arm having a connecting portion configured to connect with a saddle bag; a link extending between the first and second arms, the second arm and link pivoting about the pivot axis between a stowed position and a deployed position.

In some embodiments, when in the stowed position, the second arm and the link are positioned within the interior volume; and when in the deployed position, the second arm and at least a portion of the link are positioned outside the interior volume.

In some embodiments, the link is a first link; and the saddle bag support assembly includes a second link extending in between the first and second arms, the second link being spaced apart from the first link.

According to another aspect of the present technology, a method of deploying a saddle bag support assembly of a vehicle. The method includes accessing an interior volume defined in a frame of the vehicle; and moving the saddle bag support assembly from a stowed position, in which at least a portion of the saddle bag support assembly is positioned within the interior volume, to a deployed position, in which at least a majority of the saddle bag support assembly is positioned outside the interior volume.

In some embodiments, moving the saddle bag support assembly includes pivoting the saddle bag support assembly from the stowed position to the deployed position.

In some embodiments, the method further includes moving a passenger seat of the vehicle to access the interior volume, the passenger seat being disposed rearward of a driver seat of the vehicle.

In some embodiments, the method further includes moving a cover of the vehicle to access the interior volume, the cover being disposed rearward of a driver seat of the vehicle.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

For purposes of this application, terms related to spatial orientation such as forwardly, rearward, upwardly, downwardly, left, and right, are as they would normally be understood by a driver of the vehicle sitting thereon in a normal driving position. Terms related to spatial orientation when describing or referring to components or sub-assemblies of the vehicle, separately from the vehicle should be understood as they would be understood when these components or sub-assemblies are mounted to the vehicle, unless specified otherwise in this application. The phrase “at least one of A and B” should be understood to mean “only A, only B, or both A and B”.

Embodiments of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, rear, right side of a vehicle in accordance with an embodiment of the present technology;

FIG. 2 is a right elevation view of the vehicle of FIG. 1;

FIG. 3 is a perspective view taken from a top, rear, right side of a frame of the vehicle of FIG. 1, with a pair of saddle bag support assemblies in a stowed position;

FIG. 4 is a top plan view of the frame of FIG. 3, with the pair of saddle bag support assemblies in the stowed position;

FIG. 5 is a cross-sectional view taken along line 5-5 of FIG. 4 of the frame of FIG. 3;

FIG. 6 is a perspective view taken from a top, rear, right side of the frame of the vehicle of FIG. 1, with the pair of saddle bag support assemblies in a deployed position;

FIG. 7 is a top plan view of the frame of FIG. 6, with the pair of saddle bag support assemblies in the deployed position;

FIG. 8 is a perspective view taken from a top, rear, right side of the frame as arranged in FIG. 3, with a straddle seat and a cover; and

FIG. 9 is a perspective view taken from a top, rear, right side of the frame as arranged in FIG. 6, with the straddle seat, the cover, and accessories connected thereto.

### DETAILED DESCRIPTION

Modifications and improvements to the above-described embodiments of the present technology may become apparent to those skilled in the art. The foregoing description is intended to be exemplary rather than limiting.

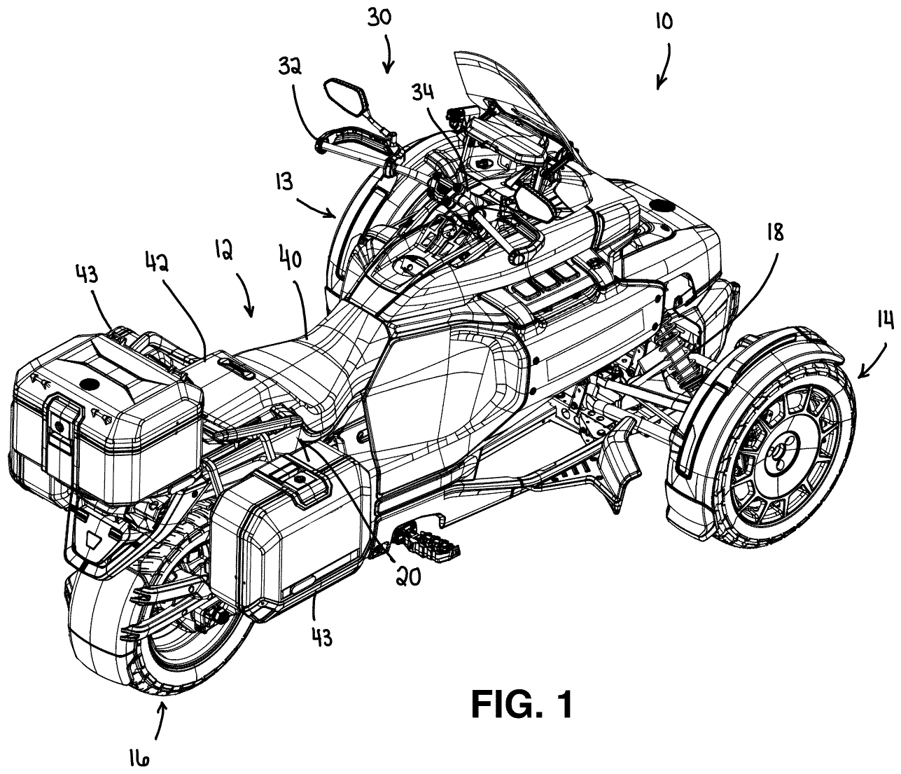

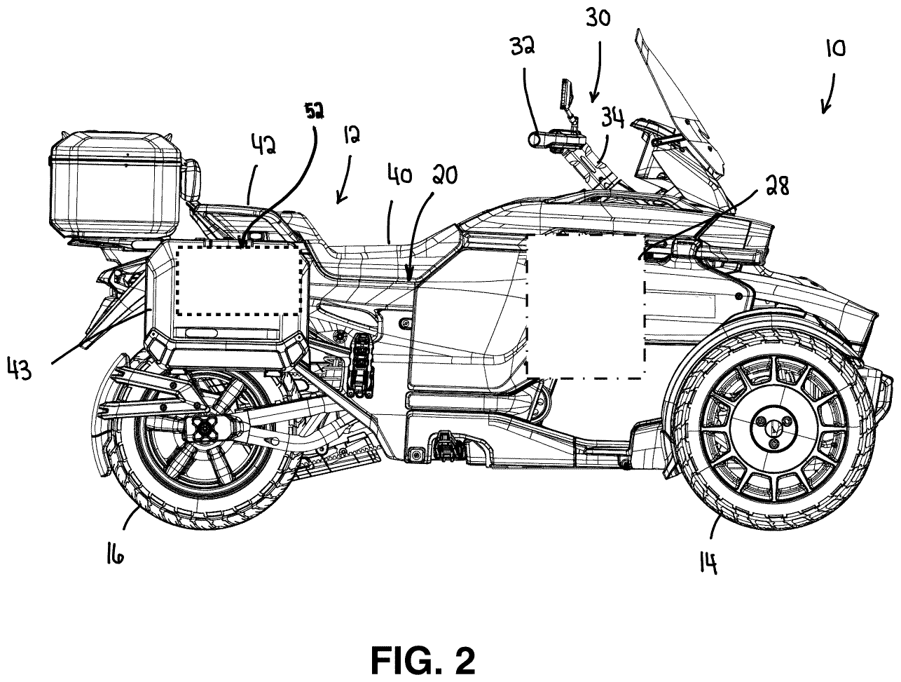

With reference to FIGS. 1 and 2, a vehicle 10 in accordance with one embodiment of the present technology is depicted. The following description relates to one example of a vehicle 10 having a straddle seat 12, specifically a three-wheel vehicle 10, referred to hereinafter as the vehicle 10. It is contemplated that the present technology could be implemented on other wheeled vehicles having a straddle seat, including but not limited to two-wheel motorcycles or four-wheel all-terrain vehicles (ATVs).

The vehicle 10 has steerable left and right front wheels 13, 14 and a single rear wheel 16. The front wheels 13, 14 are equally offset from a central longitudinal axis of the vehicle 10. The rear wheel 16 is centered between the front wheels 13, 14, aligning with the central longitudinal axis of the vehicle 10. However, it is contemplated that the vehicle 10 may be configured with two rear wheels and a single front wheel. Each front wheel 13, 14 is supported by a front suspension assembly 18. The rear wheel 16 is supported by a rear suspension assembly (not shown). The front suspension assembly 18 and the rear suspension assembly are secured to a frame 20 of the vehicle 10.

A motor 28 (schematically shown in FIG. 2) is supported by the frame 20. The motor 28 is connected to the rear wheel 16 via a transmission system (not shown) to drive the rear wheel 16. In the present embodiment, the motor 28 is a four-stroke, inline three-cylinder internal combustion engine. However, it is contemplated that the motor 28 could have more or fewer cylinders and/or could be any other type of motor, such as a two-stroke internal combustion engine or an electric motor.

The steering of the front wheels 13, 14 is achieved through a steering assembly 30. The steering assembly 30 includes a steering device 32, such as a handlebar 32, connected to a steering column 34 which is operatively connected, via steering linkages (not shown), to the front wheels 13, 14. In other embodiments, the steering device 32 may be a steering wheel. It is contemplated that the steering assembly 30 may include a power steering system.

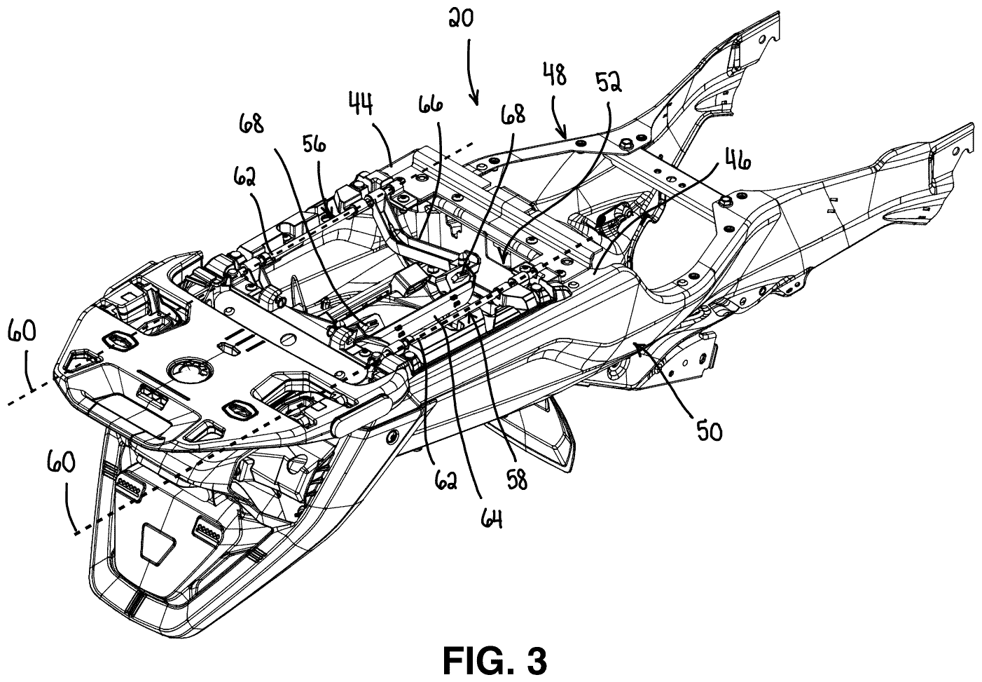

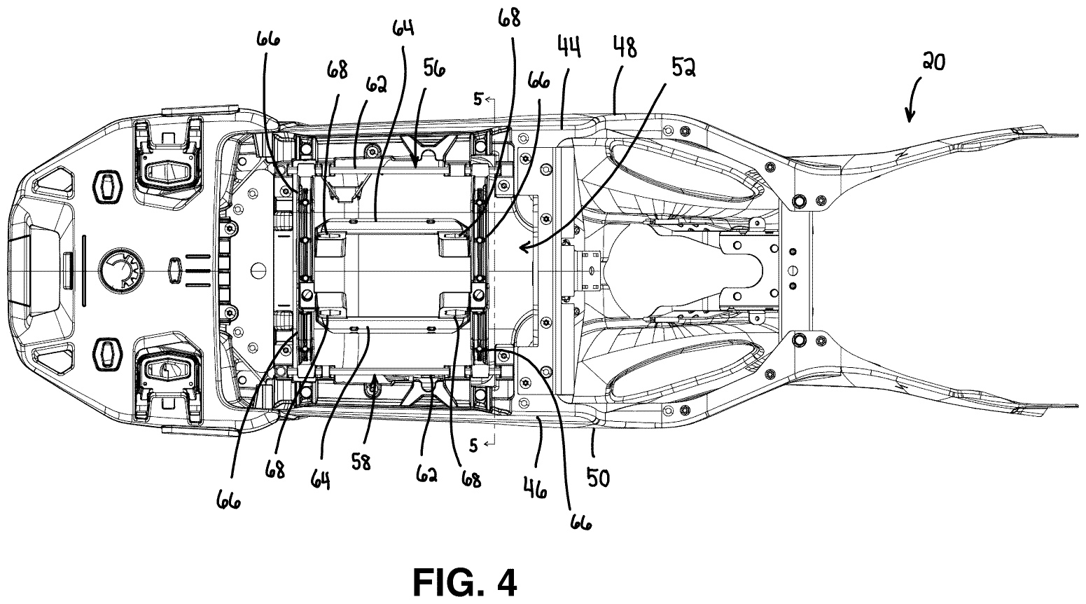

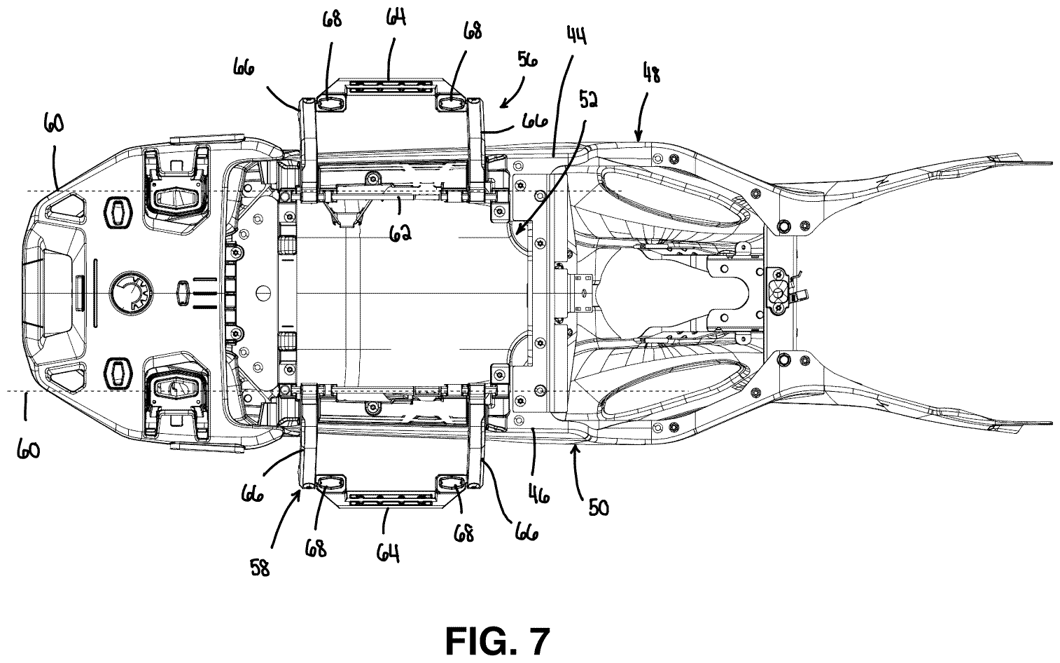

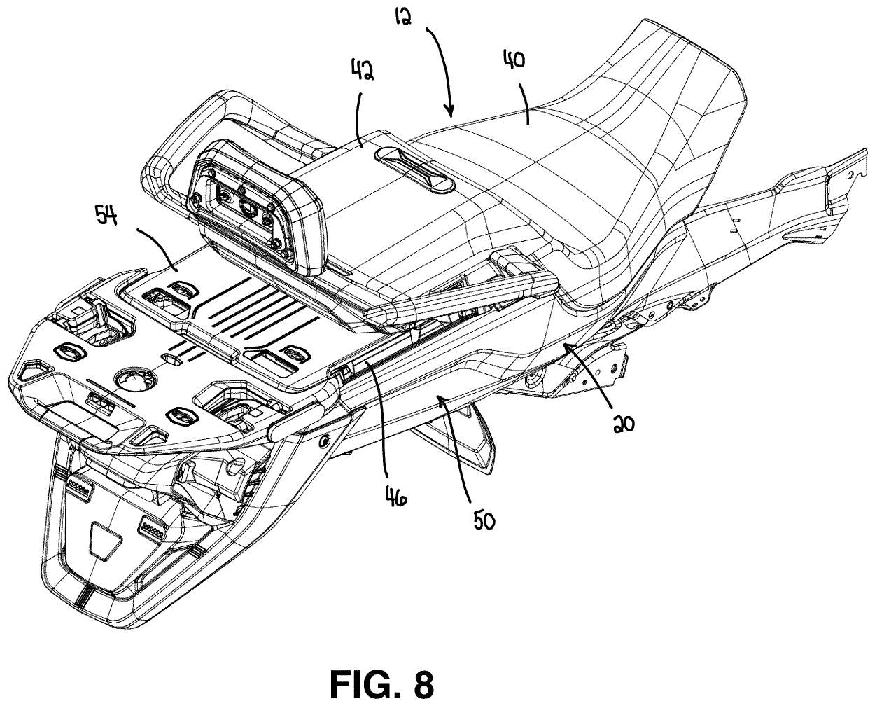

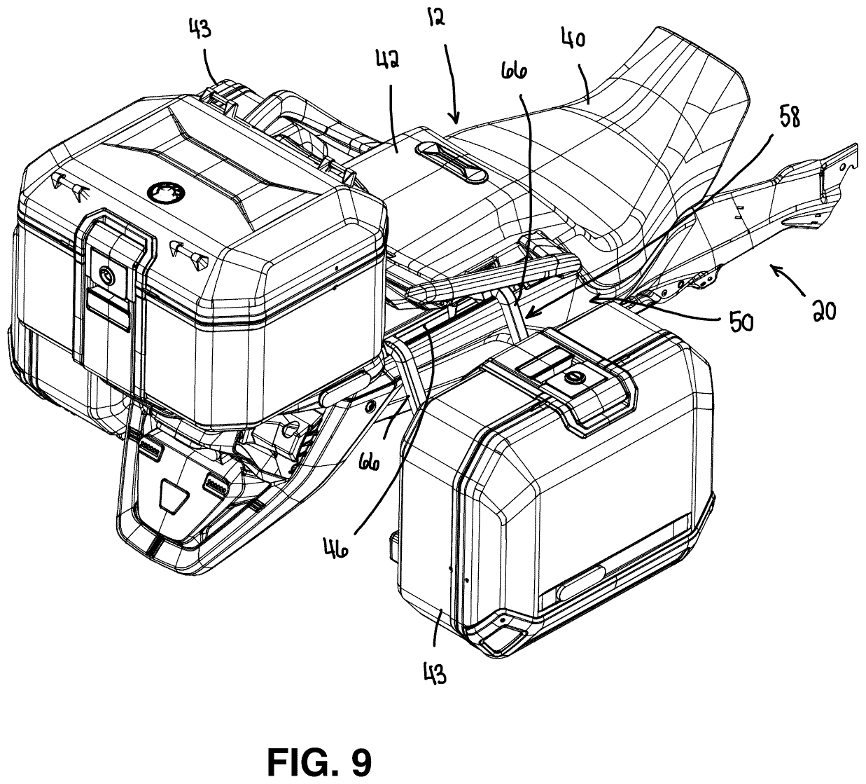

With additional reference to FIGS. 3 to 9, the straddle seat 12 of the vehicle 10 is removably connected to and supported by the frame 20. In this embodiment, the straddle seat 12 includes a driver seat portion 40 and a passenger seat portion 42 for accommodating a driver and a passenger respectively. The passenger seat portion 42 is positioned rearward of and is higher than the driver seat portion 40. The driver seat portion 40 and the passenger seat portion 42 are distinct from one another, such that each portion can be separately installed onto and removed from the frame 20. Each of the driver seat portion 40 and the passenger seat portion 42 are removably connected to a left seat rail 44 and a right seat rail 46, which are defined by an upper edge of a left panel 48 and a right panel 50 of the frame 20 respectively (as depicted in FIGS. 8 and 9). The driver seat portion 40 must be removed before the passenger seat portion 42 can be removed. It is contemplated that, in other embodiments, the straddle seat 12 could be a unitary seat, such that the driver seat portion 40 and the passenger seat portion 42 are installed onto and removed from the frame 20 together. It is further contemplated that the straddle seat 12 may only include the driver seat portion 40 and the passenger seat portion 42 may be omitted.

The frame 20 defines an interior volume 52 above the rear wheel 16. The interior volume 52 is positioned rearward of the driver seat portion 40 of the straddle seat 12 (schematically shown in FIG. 2) and extends laterally between the seat rails 44, 46. It is contemplated that the size and positioning of the interior volume 52 may vary in different embodiments.

As depicted in FIG. 8, the vehicle 10 includes a cover 54 for selectively covering the interior volume 52. In this embodiment, the cover 54 is removable from the frame 20. However, in other embodiments, the cover 54 may be designed differently to allow access to the interior volume 52, for example the cover 54 may be pivotably connected, pivoting between an opened position and a closed position.

In this embodiment, the cover 54 is positioned below the passenger seat portion 42 and rearward the driver seat 40. To access the interior volume 52, the driver seat portion 40 and the passenger seat portion 42 are first removed and the cover 54 is subsequently removed. The cover 54 is sized and shaped to avoid interfering with the seat rails 44, 46, allowing the passenger seat portion 42 to attach to the frame 20. However, in some embodiments, the passenger seat portion 42 could be mounted directly onto the cover 54. Alternatively, the cover 54 may be omitted, with the passenger seat portion 42 being configured to cover the interior volume 52, and/or the cover 54 could be integrated into the straddle seat 12.

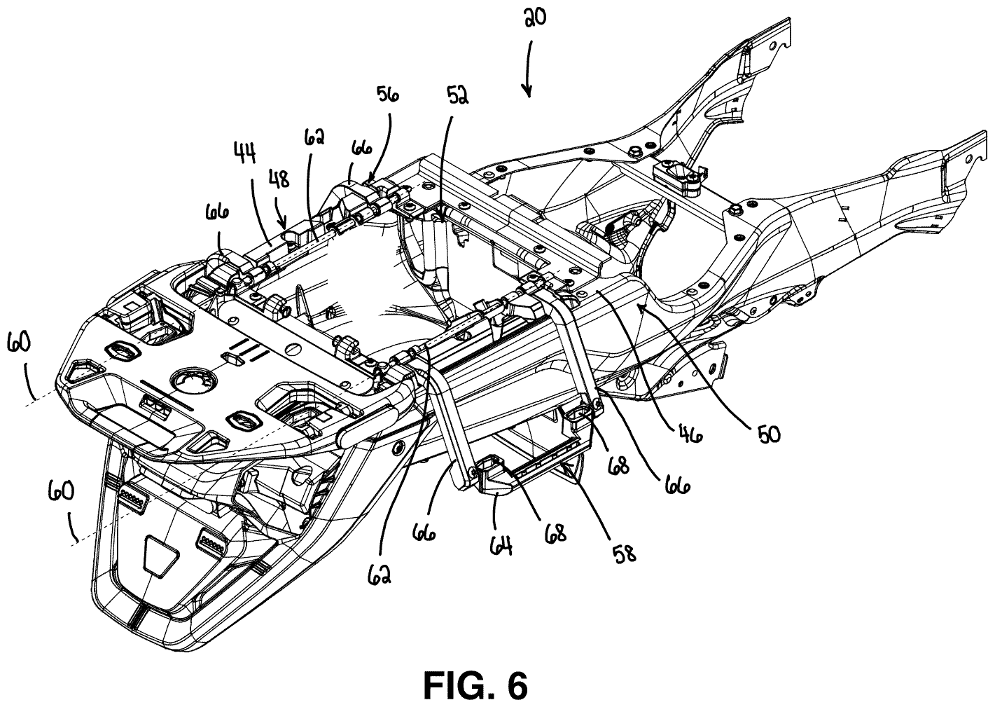

The vehicle 10 includes a left saddle bag support assembly 56 pivotably connected to a left side of the frame 20 and a right saddle bag support assembly 58 pivotably connected to a right side of the frame 20. Each of the saddle bag support assemblies 56, 58 are pivotably connected to the frame 20 within the interior volume 52 and pivot about a pivot axis 60 which extends substantially longitudinal to the frame 20. The saddle bag support assemblies 56, 58 can be pivoted between a stowed position (depicted in FIGS. 3 to 5 and 8) and a deployed position (depicted in FIGS. 6, 7, and 9). It is contemplated that the saddle bag support assemblies 56, 58 may be connected to the frame 20 differently in different embodiments.

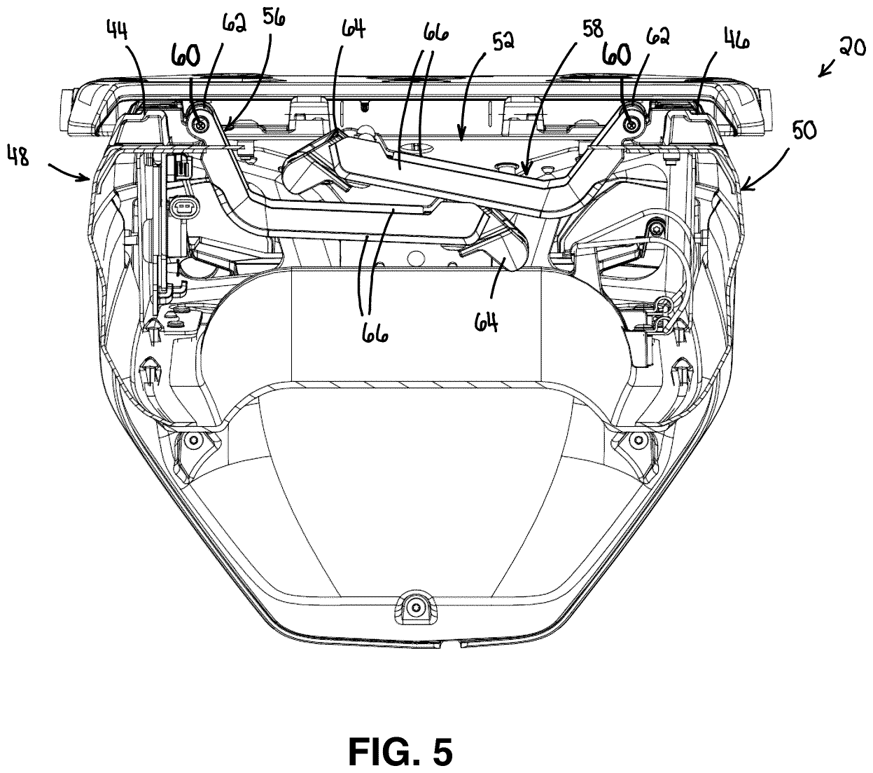

As depicted in FIGS. 3 to 5 and 8, when in the stowed position, the saddle bag support assemblies 56, 58 are stowed within the interior volume 52 of the frame. In this embodiment, the saddle bag support assemblies 56, 58 are completely housed within the interior volume 52. However, it is contemplated that a portion of each of the saddle bag support assemblies may be exposed when stowed in some embodiments. As depicted in FIG. 5, the saddle bag support assemblies 56, 58 are configured to be positioned one over the other within the interior volume 52. Although the right saddle bag support assembly 58 is positioned overtop of the left saddle bag support assembly 56, the opposite may be possible. In alternative embodiments, when stowed the saddle bag support assemblies 56, 58 may be in a side-by-side configuration or nested within one another. It is also contemplated that in alternative embodiments, the saddle bag support assemblies 56, 58 could move between stowed and deployed positions via movements other than by pivoting about an axis, for example by translation.

As depicted in FIGS. 6, 7, and 9, when in the deployed position, a majority of each the saddle bag support assemblies 56, 58 is deployed outside of the interior volume 52 to selectively receive a saddle bag 43. In other words, when deployed, a section of each of the saddle bag support assemblies 56, 58 remains within the interior volume 52, which is described in further detail below. In alternative embodiments, when the saddle bag assemblies 56, 58 are in the deployed position, they may be positioned entirely outside of the interior volume 52.

With continued reference to FIGS. 3 to 7, the saddle bag support assemblies 56, 58 will be described in further detail. In this embodiment, the left and right saddle bag support assemblies 56, 58 have the same configuration. Therefore, for clarity, only the right saddle bag support assembly 58, referred to hereinafter as the saddle bag support assembly 58, will be described in detail.

The saddle bag support assembly 58 includes an upper arm 62 and a lower arm 64 extending substantially parallel to and spaced apart from one another. The upper arm 62 and the lower arm 64 are connected to one another via two spaced apart links 66. The links 66 extend parallel to one another. One of the links 66 connects a rear end of the upper arm 62 to a rear end of the lower arm 64 and the other link 66 connects a front end of the upper arm 62 to a front end of the lower arm 64. The number of links 66 and/or the number of arms 62, 64 and their configurations may vary in different embodiments.

The upper arm 62 is pivotably connected to the right side of the frame 20 within the interior volume 52. The upper arm 62 extends along an upper surface of the frame 20, substantially parallel to the right seat rail 46. In this embodiment, the upper arm 62 defines the pivot axis 60, such that the lower arm 64 and the links 66 pivot about the upper arm 62 between the stowed position and the deployed position.

As discussed above, when in the stowed position, the saddle bag support assembly 58 is completely housed within the interior volume 52. That is, the upper arm 62, lower arm 64, and the links 66 are within the interior volume 52.

To move the saddle bag support assembly 58 from the stowed position to the deployed position, the lower arm 64 is pivoted about the upper arm 62. Specifically, the lower arm 64 pivots outwardly, away from the central longitudinal axis of the vehicle 10. When in the deployed position, the upper arm 62 and an upper end of each of the links 66 are within the interior volume 52, while the remainder of the links 66 and the lower arm 64 are positioned outside of the interior volume 52. The seat rails 44, 46 define two recesses to receive the upper end of each of the links 66, such that the cover 54 sits flush when covering the interior volume 52.

The lower arm 64 is configured to connect with the saddle bag 43. In this embodiment, the lower arm 64 defines two apertures 68, one at either end of the lower arm 64. The apertures 68 are configured to receive a respective latch (not shown) connected to a bottom surface of the saddle bag 43. The latches of the saddle bag 43 are moveable between a locked position, which secures the saddle bag 43 to the saddle bag support assembly 58, and an unlocked position, releasing the saddle bag 43 from the saddle bag support assembly 58. It is noted that the connection between the lower arm 64 and the saddle bag 43 may vary in other embodiments.

To move the saddle bag support assembly 58 from the deployed position to the stowed position, the lower arm 64 is pivoted about the upper arm 62. Specifically, the lower arm 64 pivots inwardly, towards the central longitudinal axis of the vehicle 10.

The above description mentions the left and right saddle bag assemblies 56, 58. However, it is noted that alternative embodiments may incorporate any number and positioning of saddle bag support assemblies. Additionally, in further alternative embodiments, the saddle bag support assemblies may not be limited to connecting to only the saddle bags 43 but could also attach to other vehicle accessories and/or devices.

Modifications and improvements to the above-described embodiments of the present technology may become apparent to those skilled in the art. The foregoing description is intended to be exemplary rather than limiting.

What is claimed is:

1. A vehicle comprising:
a frame defining an interior volume;
at least two wheels attached to the frame;
a driver straddle seat supported by the frame and positioned at least partially forward of the interior volume; and
a saddle bag support assembly connected to the frame, the saddle bag support assembly being moveable between:
a stowed position, in which at least a portion of the saddle bag support assembly is stowed within the interior volume; and
a deployed position, in which at least a majority of the saddle bag support assembly is deployed outside the interior volume, the saddle bag support assembly being configured and arranged to selectively receive a saddle bag when in the deployed position.

2. The vehicle of claim 1, wherein:
the frame defines:
a first seat rail; and
a second seat rail spaced apart from the first seat rail; and
the interior volume is defined between the first and second seat rails.

3. The vehicle of claim 2, wherein:
the frame comprises:
a first side panel, where a portion of an upper edge of the first side panel defines the first seat rail; and
a second side panel, where a portion of an upper edge of the second side panel defines the second seat rail.

4. The vehicle of claim 1, wherein one of the at least two wheels is a rear wheel disposed under the interior volume.

5. The vehicle of claim 1, further comprising a passenger straddle seat removably connected to the frame above the interior volume.

6. The vehicle of claim 1, further comprising a cover configured to selectively cover the interior volume.

7. The vehicle of claim 1, wherein the saddle bag support assembly is pivotably connected to the frame.

8. The vehicle of claim 7, wherein the saddle bag support assembly is configured to pivot about a pivot axis extending substantially longitudinal to the frame.

9. The vehicle of claim 8, wherein the saddle bag support assembly comprises:
a first arm extending along a side of the frame, the first arm defining the pivot axis;
a second arm extending substantially parallel to the first arm, the second arm having a connecting portion configured to connect with the saddle bag; and
a link extending between the first and second arms.

10. The vehicle of claim 9, wherein, when in the saddle bag support assembly is in the deployed position, the second arm and at least a portion of the link is deployed outside of the interior volume.

11. The vehicle of claim 9, wherein:
the connecting portion is a first connecting portion having a first aperture defined in the second arm; and
the second arm has a second connecting portion spaced apart from the first connecting portion, the second connecting portion having a second aperture defined in the second arm.

12. The vehicle of claim 1, wherein:
the frame comprises:
a first side; and
a second side, the second side being opposite the first side;
the saddle bag support assembly is a first saddle bag support assembly connected to the first side of the frame; and
the vehicle further comprises a second saddle bag support assembly connected to the second side of the frame.

13. The vehicle of claim 1, further comprising the saddle bag selectively connected to. the saddle bag support assembly in the deployed position.

14. The vehicle of claim 1, wherein the saddle bag support assembly is connected to the frame within the interior volume.

15. A saddle bag support assembly for a vehicle, the saddle bag support assembly comprising:
a first arm configured to connect to a frame of the vehicle and extend along a side of the frame, the first arm defining a pivot axis;
a second arm extending substantially parallel to the first arm, the second arm having a connecting portion configured to connect with a saddle bag;
a link extending between the first and second arms; and
the second arm and link pivoting about the pivot axis between a stowed position and a deployed position.

16. The saddle bag support assembly of claim 15, wherein:
when in the stowed position, the second arm and the link are positioned within the interior volume; and
when in the deployed position, the second arm and at least a portion of the link are positioned outside the interior volume.

17. A method of deploying a saddle bag support assembly of a vehicle, the method comprising:
accessing an interior volume defined in a frame of the vehicle; and
moving the saddle bag support assembly from a stowed position, in which at least a portion of the saddle bag support assembly is positioned within the interior volume, to a deployed position, in which at least a majority of the saddle bag support assembly is positioned outside the interior volume.

18. The method of claim 17, wherein moving the saddle bag support assembly comprises pivoting the saddle bag support assembly from the stowed position to the deployed position.

19. The method of claim 17, further comprising moving a passenger seat of the vehicle to access the interior volume, the passenger seat being disposed rearward of a driver seat of the vehicle.

20. The method of claim 17, further comprising moving a cover of the vehicle to access the interior volume, the cover being disposed rearward of a driver seat of the vehicle.
